(19) United States
(12) Patent Application Publication
(10) Pub. No.: US 2015/0370322 A1
(43) Pub. Date: Dec. 24, 2015

(54) METHOD AND APPARATUS FOR BEZEL MITIGATION WITH HEAD TRACKING

(71) Applicant: Advanced Micro Devices, Inc., Sunnyvale, CA (US)

(72) Inventor: John L. Gustafson, Pleasanton, CA (US)

(21) Appl. No.: 14/307,907

(22) Filed: Jun. 18, 2014

(51) Int. Cl. G06F 3/01; G06F 3/14

(52) U.S. Cl. CPC G06F 3/012; G06F 3/1423

(57) ABSTRACT

The present disclosure presents methods and apparatuses for operating a multi-display device to mitigate the effects of image interruption due to bezels between individual display devices. For example, a method of operating a video device includes generating a bezel-corrected image which spans a plurality of display devices, the bezel-corrected image including masked image pixels, wherein the masked image pixels are associated with a bezel of at least one of the plurality of display devices. Such example methods may further include detecting a head position change of a user and displaying one or more of the masked image pixels on at least one of the plurality of display devices based on the head position change.

### BACKGROUND OF THE DISCLOSURE

The present disclosure is related to systems having multiple displays wherein the multiple displays may be used to display a single image over the surface area of the combined displays, that is, to form a single large surface display, and to providing compensation for the bezels surrounding the borders of the individual displays forming the single large surface display.

Various computing applications, such as gaming applications, use multiple displays to increase the surface area over which visual information may be displayed to a user. A plurality of monitors may be arranged in, for example, a tiled arrangement to form a single imaging surface that can display a partitioned image. Unlike very large displays, tiled displays are inexpensive ways of obtaining an equivalent number of pixels. Furthermore, the ability to drive multiple displays is beginning to allow a number of new display combinations.

Displays include an outer border, which is sometimes referred to as the display's bezel. When tiling multiple displays together in multiple monitor arrangements, the bezel of each display hinders the immersive experience when displaying a continuous image across the multiple displays. The alternative of using a single large display is costly and can result in the possible decrease in performance in refresh rates and input delays when driving such a large number of pixels in a single device. The cost of display devices grows superlinearly with the number of pixels, whereas the technique of tiling displays grows the cost of a similar number of pixels linearly though limited by the video hardware. Another alternative is to use multiple projector display devices and match the boundaries and colors for a seamless, bezel-less continuous image. However, this implementation is far less common than direct-view display devices, especially when considering desktop computing, and is only practical in low-light installations. Also the image is easily interrupted by an occluding object, require large installation spaces, specialty installation hardware, and aligning and/or calibrating colors for the multiple projected images can be quite cumbersome and inconsistencies are much more easily detectable by the human eye. There exist bezel compensation methods that correct for discontinuities in a continuous image displayed across multiple adjacent displays. The multiple display devices are aligned by a user to provide the appearance of a single image viewed through a paned window, with the bezels appearing as the divider between panes. A portion of the image, i.e. some of the pixels of the single large image surface, appears to be hidden behind the bezels, but still aligned from one display to the other in order to provide the desired effect. However, since part of the image is missing, this may not be ideal for some gaming and non-gaming situations such as displaying text, maps, and for most graphics applications because the hidden pixel information maybe vital to the task at hand.

Accordingly, there exists a need to provide methods and apparatuses to mitigate the bezel interference for a group of tiled displays participating in a single large surface configuration.

### BRIEF DESCRIPTION OF THE DRAWINGS

The disclosure will be more readily understood in view of the following description when accompanied by the below figures and wherein like reference numerals represent like elements, wherein:

FIG. 1 is block diagram illustrating an example bezel mitigation system according to aspects of the present disclosure;

FIG. 2A illustrates one example of an embodiment of a test object before bezel-correction;

FIG. 2B illustrates one example of an embodiment of the test object after bezel-correction;

FIG. 3 is a block diagram illustrating aspects of a computer device according to the present disclosure;

FIG. 4 is a flow diagram illustrating aspects of a method for supporting improved uplink control message prioritization as provided by the present disclosure; and

FIG. 5 is a component diagram illustrating aspects of a logical grouping of electrical components as contemplated by the present disclosure.

### DETAILED DESCRIPTION OF EMBODIMENTS

Briefly, apparatus and methods are disclosed that provides real-time user tracking for mitigating the effects of bezels of multiple display devices tiled or arranged in a grid that are configured to display a single continuous image or scene. The disclosed embodiments provides a field of view (FOV) which is larger than the available pixels of the physical display devices such that when a user moves his or her head, the notational camera or reference point of the enlarged FOV is modified or offset to display graphics objects outside of the pixel space of the display device, yet within the enlarged FOV. The enlarged FOV, when displayed to a user, resembles how the scene would be displayed if it were farther away than the actual physical position of the display devices. By tracking the position of the user's head, the apparatus can simulate looking through a window pane where head motion allows the viewer to see an object that is occluded, i.e. graphical objects outside of the viewable area of the display device yet still rendered within the enlarged FOV.

Thus, the present disclosure presents methods, apparatuses, and systems for bezel mitigation in multi-display devices. For example, in an aspect, the present disclosure presents a method of operating a video device, which includes generating a bezel-corrected image which spans a plurality of display devices, the bezel-corrected image including masked image pixels, wherein the masked image pixels are associated with a bezel of at least one of the plurality of display devices. Such methods may also include detecting a head position change of a user and displaying one or more of the masked image pixels on at least one of the plurality of display devices based on the head position change.

In additional examples, the present disclosure presents an example video device including a plurality of display devices configured to display an image which spans continuously across the plurality of display devices, at least one processor, and memory operatively coupled to the at least one processor. In such examples, the memory may contain instructions for execution by the at least one processor, wherein at least one processor, upon executing the instructions, generates a bezel-corrected image that spans the plurality of display devices, the bezel-corrected image including masked image pixels, wherein the masked image pixels are associated with a bezel of at least one of the plurality of display devices, detect a head position change of a user, and display one or more of the masked image pixels on at least one of the plurality of display devices based on the head position change.

Furthermore, the present disclosure presents an example computer readable memory comprising executable instructions for execution by at least one processors, that when executed cause the at least one processor to generate a bezel-corrected image which spans a plurality of display devices, the bezel-corrected image including masked image pixels, wherein the masked image pixels are associated with a bezel of at least one of the plurality of display devices, detect a head position change of a user, and display one or more of the masked image pixels on at least one of the plurality of display devices based on the head position change.

The embodiments herein disclosed also include a computer readable memory storing executable instructions for execution by at least one processor, that when executed cause at least one processor to perform all of the methods of operation as outlined above. The computer readable medium may be any suitable computer readable medium such as, but not limited to, a server memory, CD, DVD, hard disk drive, flash ROM (including a “thumb drive”) or other non-volatile memory that may store and provide code to be executed by one or more processors.

The field of view (FOV) is the extent of the observable world that is seen at any given moment. In computer graphics, the FOV refers to the display region a user would see of a rendered world, which is dependent on the scaling method used. The FOV is usually given as an angle for the horizontal or vertical FOV. The FOV increases with a larger angle. For example, if the horizontal/vertical FOV is 90°, then 25% of the horizontal/vertical space in the 360° modeled world will be viewable.

In 3D computer graphics, the viewing frustum or view frustum is the region of space in the modeled world that may appear on the display device; it is the field of view of a vector camera. The vector camera has a projection reference point that defines the view frustum. The exact shape of this region varies depending on what kind of camera lens is being simulated, but typically it is a frustum of a rectangular pyramid. The planes that cut the frustum perpendicular to the viewing direction are called the near plane and the far plane. Objects closer to the camera than the near plane or beyond the far plane are not drawn.

View frustum culling is the process of removing objects that lie completely outside the view frustum from the rendering process. Rendering these objects can be a waste of time since they are not directly visible to the user. To make culling fast, it is usually done using bounding volumes or boxes surrounding the objects rather than the objects themselves. If an object's bounding box is outside of the view frustum, the object is typically culled.

The method and apparatus extends the viewing frustum beyond that of the physical image pixels of a display device such that when user head motion is detected, a graphical processing unit generates a virtual view frustum that has a wider and deeper field of view. When the apparatus detects a change in the position or rotation of a users head, the viewing frustum is adjusted to reveal objects that are outside of the range of the physical image pixels that are typically culled. Rather than culling the non-visible objects, the apparatus renders the objects that are outside of viewable area and displays them according to the user's head movements. The vector camera's projection reference point is adjusted based on the user's head movements, e.g. the projection reference point can be translated and/or rotated in three dimensions according to detected translation and/or rotation movement of the user's head to mitigate the effect of the display device bezel on the user. The user's experience is akin to looking through a window, for example, peeking around the edge of the window to see the side of a building or moving forward towards a window to see a greater range, i.e. a greater FOV, of objects outside of the window. When using multiple display devices in a tiled arrangement to extended the viewable area continuously across the multiple display devices, the presence of each display device bezel, especially the bezel along a common border between adjacent display devices, can be distracting to the user when performing graphics intensive tasks including, but not limited to, CAD applications, image/video editing applications, video gaming, and the like. Current bezel compensation methods account for the bezel thickness between adjacent display devices to make objects continuous across the border threshold between adjacent displays to form a Single Large Surface (SLS) display grid.

To form an SLS display grid, independent display are arranged in various row and column combinations. For example, four displays that each have a resolution of 1920×1200 pixels can be arranged in a 2×2 grid which provides an SLS pixel resolution of 3840×2400. In another example, the four 1920×1200 resolution displays can be arranged in a 4×1 arrangement which provides an SLS pixel resolution of 7680×1200. Although the exemplary embodiments disclosed herein involve a rectangular grid for simplicity of explanation, other implementations are possible in accordance with the embodiments. Other exemplary display arrangements that may be obtained in accordance with the embodiments include, but are not limited to: 1 wide by 3 high, 2 wide by 2 high, and 3 wide by 2 high. The subdivision can be hierarchical; for example, a subdivision could be 2 high, but the top subdivision could then be split 3 wide independently of the bottom subdivision. The displays need not be the same size or the same resolution. That is, the embodiments support a number of arrangements including various single row, and multiple row topologies (not all topologies including the same number of displays in the rows and/or columns of the grid).

To configure bezel compensation for a plurality of displays forming the SLS display grid, a user is typically provided via an easy to use graphical user interface (GUI) that shows a test image such as an easily identifiable geometric shape, or other appropriate image, on the displays to be configured, with a portion of the geometric shape extending “underneath” the bezel area with a portion of the shape displayed on a neighboring display. Examples of geometric shapes may include lines, triangles, squares, rectangles, ellipses, and the like. Prior to the compensation procedure, the test image looks discontinuous and broken because the bezel thickness between neighboring displays is assumed to be zero. To align the viewable area of each display, the user may align and position the test image along the bezels by using a set of control buttons that enable positioning and aligning of the geometric shape until the test image looks continuous. Based on the relative change in horizontal and vertical position of the test image in each display, the logical coordinates of the corresponding displays viewable area is adjusted such that the test image/geometric shape looks continuous underneath the bezel area.

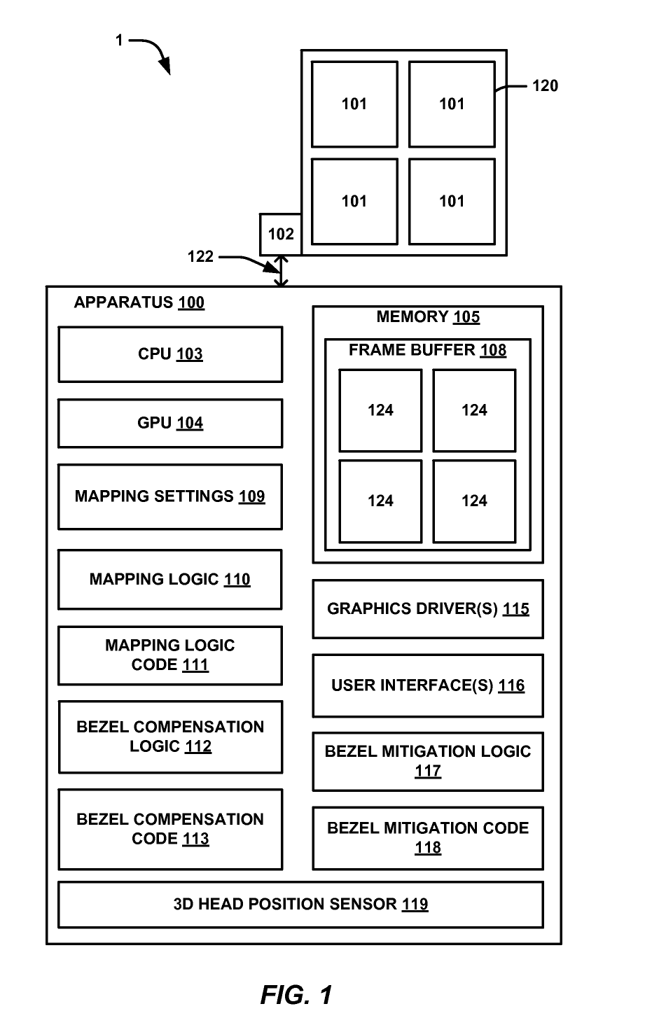

Turning now to the drawings wherein like numerals represent like components, FIG. 1 is a block diagram of a system 1 including an apparatus 100 connected to a plurality 120 of displays 101 in accordance with the various embodiments, such as in a tiled or rectangular arrangement. Each individual display 101 is connected to the apparatus 100 via cabling 122 to a series of connector ports 102, each connector port 102 having a unique identifier or logical port number associated with each display 101. The display 101 can be connected to each connection port 102 wirelessly or with a combination of wireless and cabled/wired connection ports 102. In some embodiments, the displays 101 are connected in a daisy-chain fashion in which only one or two displays 101 are connected directly to the connection ports 102 and the remaining displays 101 are connected via the directly connected displays 101. In the daisy-chain embodiment, all of the displays 101 are still assigned a logical port number. The logical port numbers are used to map the position of the displays 101 in relation to one another to form the SLS grid.

In some embodiments, the apparatus 100 may include a central processing unit (CPU) 103 and a graphics processing unit (GPU) 104, which, in some examples, may be associated with a single layer PC board (e.g., in a video game console). In other embodiments, the apparatus 100 may be a computer system consisting of multiple PC boards such as a graphics processing card which includes the GPU 104, and a motherboard which includes the central processing unit 103. Further, the CPU 103 and GPU 104 may each include one or more processing cores and may be physically located on separate integrated circuits, or on a single integrated circuit die. In some embodiments, the CPU 103 and GPU 104 may be located on separate printed circuit boards within apparatus 100. Also in some embodiments, multiple CPUs and/or GPUs may be operatively coupled to each other and to multiple sets of connector ports 102. Memory 105 is a representation of system memory that may be in any suitable location within the apparatus 100.

Other necessary components, as understood by those of ordinary skill, may also be present within the apparatus 100. Therefore, it is to be understood that, in addition to the items shown which are shown for the purpose of explaining to those of ordinary skill how to make and use the various embodiments herein disclosed, other components may be present as would be required and as would be understood by one of ordinary skill to be present such that the apparatus 100 will be a fully functional apparatus. For example, a memory controller may be present and may interface between, for example, the CPU 103 and memory 105. However such additional components are not shown, as they are not necessary for providing an understanding of the presently disclosed embodiments.

Therefore in accordance with an example embodiment, the apparatus 100 includes at least the CPU 103, the GPU 104, and memory 105, all or a subset of which may operatively coupled by a communication bus or other communication line. As discussed above with respect to apparatus 100, internal components, such as, but not limited to, the communication bus, may include other components which are not shown but would be necessary to the operation of the apparatus 100 as would be understood by those of ordinary skill. The plurality of display ports 102 may also be operatively connected to the communication bus (e.g., via cabling 122) and may also therefore be operatively connected to the CPU 103, the GPU 104, and the memory 105. The memory 105 includes a frame buffer 108. The frame buffer 108 may alternatively in some embodiments be included in a dedicated memory of GPU 104, or in yet another alternative embodiment may be distributed between system memory 105 and GPU 104 dedicated memory.

In an aspect, frame buffers 108 may store virtual images that the user would see if the virtual image were at a distance behind the screen. Graphics transforms (e.g., 3D-2D shaders), which may be built into GPU 103, can readily compute this apparent image. Furthermore, the visible portion of the virtual image may be treated as a 3D graphics object beyond the display that must be rendered into 2D on the physical display devices 101. Each frame buffer contains additional border information outside of a visible region on the plurality 120 of display devices 101, which are ready to transform and display should the user change his or her head position.

As shown in FIG. 1, the frame buffer 108 is partitioned into a set of image data portions 124 corresponding to the arrangement of the plurality 120 of display devices 101, which may be referred to herein as the SLS display grid. For example, as shown, the frame buffer 108 is partitioned to include four image data portions 124, in a two by two grid arrangement, such that each image data portion 124 corresponds to a physical display. The individual image data portions 124 may be considered as corresponding to the image portions viewed through windowpanes of a large rectangular window. The rectangular arrangement of the frame buffer 108 is set up to correspond with the physical arrangement of the plurality 120 of displays 101 that is initially expected, for example, a default arrangement. This initially expected arrangement, or default arrangement, and the corresponding initial mapping of displays to the frame buffer 108, may be based on, for example, the logical designations of the physical ports 102 to which each of the plurality of displays 101 is connected. As discussed above, some embodiments may employ daisy-chained displays in which case such daisy-chained displays will likewise have “initially expected” logical positions that are similarly initially mapped to the frame buffer 108. In other words, when a group of displays is initially connected, via any suitable means, (cables, wireless ports, daisy-chaining, or combinations thereof), each display is initially mapped to an image data portion of the frame buffer 108.

This mapping may be considered a default mapping based simply on the physical connections. However, if the displays are arranged in an order that differs from the expected or default order, the image displayed by the group will appear out of order and therefore will appear scrambled. The user may then therefore perform a configuration operation, in accordance with the embodiments, to correct the mapping of the frame buffer to match the actual physical arrangement of the plurality of displays 101 forming the SLS display grid and thereby unscramble the displayed image. Of course, such a scrambled image need not be initially actually displayed. However imagining the appearance of such a scrambled image is helpful toward understanding the operation of the various embodiments. The mapping information is stored as mapping settings 109, in memory 105, and is accessible by SLS mapping code 110 as will be described in further detail below.

In accordance with the embodiments, the mapping settings 109 are used by the CPU 103, and/or the GPU 104, to correctly display the logical image data portions of the frame buffer 108 on the correct displays of the plurality of displays 101 with respect to the displays' actual physical location, i.e., each display's logical coordinates within the SLS display grid arrangement. In accordance with the embodiments, the mapping logic 110 provides a user interface and obtains user data so that the mapping of the displays' physical positions (SLS display grid coordinates) to the frame buffer may be accomplished to create mapping information within the mapping settings 109. In some embodiments, the mapping logic 110 may also include the mapping logic code 111. That is, the CPU 103 may execute the mapping code 110 (as executable instructions) from the memory 108 in some embodiments. In other embodiments the mapping logic 110 may operate independently, that is, without any mapping logic code 111. As one example, when each display has its own head tracking camera, the re-mapping of the SLS can be computed automatically. If the display configuration file knows where the camera is relative to the display, and the geometry of the display it belongs to, then the new mappings can be calculated. For example, one monitor can display a message asking the user to move his or her head left to right slightly, then up to down slightly. The display grid notes the head motion, which is different for each camera just as a stereoscopic view is different for each of our eyes, which allows us to infer location in three dimensions. The computers then compute the xyz position of the user's head consistent with the up-down, left-right motion just seen by the cameras.

The term “logic” as used herein may include software and/or firmware executing on one or more programmable processors (including CPUs and/or GPUs), and may also include ASICs, DSPs, hardwired logic or combinations thereof. Therefore, in accordance with the embodiments, the mapping logic and/or other logic may be implemented in any appropriate fashion and would remain in accordance with the embodiments herein disclosed. The term “display” as used herein refers to a device (i.e. a monitor) that displays an image or images, such as, but not limited to, a picture, a computer desktop, a gaming background, a video, an application window etc. The term “image” as used herein refers generally to what is “displayed” on a display (such as a monitor) and includes, but is not limited to, a computer desktop, a gaming background, a video, an application window etc. An “image data portion” as used herein refers to, for example, a logical partition of an image that may be mapped to at least one display of a plurality of displays. The mapping of image data portions to displays within an arrangement of a plurality of displays enables the plurality of displays to act in concert as an SLS display.

After the displays are mapped to SLS grid coordinates, (and also to the image data portions of the frame buffer 108), the SLS display grid is ready to be configured for bezel compensation. In accordance with the embodiments, bezel compensation logic 112 provides a user interface or “bezel configuration wizard” to enable a user to proceed to adjust the displays in order to compensate for the bezels, and also any physical spacing, between the viewable surface areas of the displays forming the SLS display grid. The bezel configuration wizard may include one or more application windows that guide a user through the bezel configuration process. In some embodiments the bezel compensation logic 112 may be integrated with the mapping logic 110. In some embodiments, the bezel compensation logic 112 may use the bezel compensation code 113. That is, the CPU 103 may execute the bezel compensation code 113 (as executable instructions) from the memory 105 in some embodiments. In other embodiments the bezel compensation logic 112 may operate independently, that is, without any bezel compensation code 113. The bezel compensation logic 112 will initially communicate, via the operating system (OS) 114, with graphic drivers 115 to determine whether the various displays making up the SLS display are amenable to bezel compensation. That is, the graphics drivers 115 will examine the physical capabilities of the displays, such as for example, but not limited to, a display's pixel density. The bezel compensation logic 112 obtains this information from the graphics drivers 115 and will enable bezel compensation configuration only for those displays of the SLS that are suitable for bezel compensation.

The bezel compensation logic 112 obtains input from the user interfaces 116, which include any suitable user interface and/or peripheral such as, but not limited to, a keyboard, mouse, microphone, gyroscopic mouse, or soft controls displayed on a graphical user interface (GUI) displayed on one or more of the displays, etc. The bezel compensation logic 112 communicates with an operating system (OS) 114 and interfaces with one or more graphics drivers 115 via the OS 114. The graphic drivers 115 may be executed by the CPU 103, GPU 104 or may involve some combination of operations by both the CPU and GPU. The graphics drivers 115 are capable of driving the multiple displays, such as plurality of displays 100, to form an SLS display grid.

The bezel compensation logic 112 may be considered as providing “displayable information” to the displays via the OS 114 and graphics drivers 115, in that, for example, the visual test objects/images are displayed as determined by the bezel compensation logic 112. The displayable information is therefore information that is output to the displays and that the displays utilize to display graphical user interfaces (GUIs), visual test objects, control buttons, etc. The visual test objects may be, for example, a geometric shape, (2-dimensional or 3-dimensional), or a graphical representation of a physical object (such as a table, chair, tree, etc.), a character (such as a game avatar, etc.).

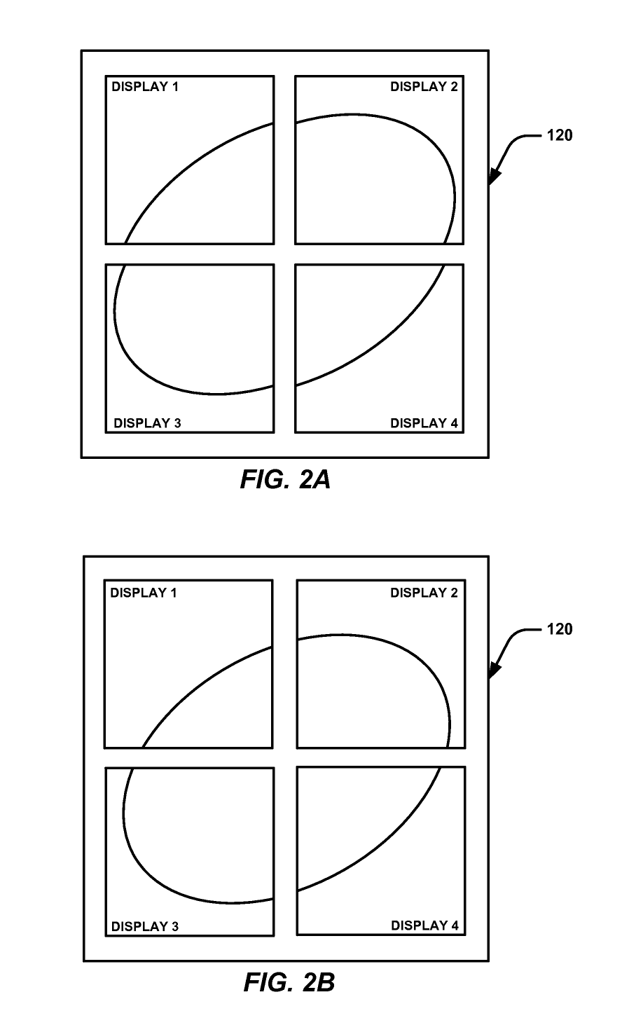

An SLS configuration application window that may be provided by the mapping logic 110 as previously discussed. A user may, for example, receive a notification and may use a mouse cursor to select a desired SLS configuration from a menu. For example, the user may select a two-display configuration of the plurality 120 of display devices with “2 wide by 2 tall” as shown in FIG. 2A. After the SLS display grid is configured and the mapping settings 109 are created, the SLS displays may be configured for bezel compensation. A bezel compensation configuration application window may be provided by the bezel compensation logic 112 such as a “bezel compensation wizard”. The bezel compensation wizard displays a visual test object on the viewable area of the adjacent displays 101 to be configured. As illustrated in FIG. 2A, the visual test object is an ellipse that spans across the four display devices (Displays 1-4 of FIG. 2A and FIG. 2B) that form the SLS. The ellipse appears discontinuous because the spacing of the bezel between neighboring displays is assumed to be zero. The bezel compensation method of the embodiments accounts for any such spacing between the viewable area such that the visual test object appears “hidden” behind the bezel portion as shown in FIG. 2B where the ellipse appears continuous behind a “window pane”. The user operates the user interface 116 to move a first portion of the visual test object shown on a first display into alignment with a second portion of the visual test object shown on a second neighboring or adjacent display. This is repeated until all the portions of the visual test object are in line with one another as shown in FIG. 2B. In accordance with the example of FIGS. 2A and 2B, the first portion of the ellipse displayed on Display 1 is moved in relation to neighboring Display 2 and Display 3 until the second portion (shown in Display 2) and the third portion (shown on Display 4) are in alignment with one another. This is repeated for Displays 1-4 until all four portions of the ellipse are aligned as illustrated in FIG. 2B.

Returning to FIG. 1, after the SLS display grid is configured and the bezel compensation is configured for all of the plurality 120 of display devices 101 which form the SLS and in turn generates a known physical position with respect to each display, the SLS displays maybe configured for bezel mitigation. As previously discussed, after a bezel compensation method has been applied the viewable area of the display grid appears similar to a large rectangular window having window panes where a portion of the image, i.e. some of the pixels that form the SLS, appears hidden behind or masked by the bezels but still remains aligned between adjacent or neighboring displays. When provided an obstructed view, a natural instinct is to look around an obstruction to see a hidden object, e.g. the masked pixels corresponding to the display bezels that form the SLS. Similar to a user moving their head in order to see around the panes of the window, a user may move their head to see around the bezels between neighboring displays to see the masked pixels which correspond to a hidden object or portion of a hidden object. In accordance with the embodiments, bezel mitigation logic 117 provides an enhanced viewing frustum which includes 2D and/or 3D objects which are typically “hidden” behind the bezels. When changes in the head position of the user are detected, the hidden are objects are revealed on the viewable area of a corresponding display device 101 based on the amount of movement detected. In some embodiments, the bezel mitigation logic 117 may use the bezel mitigation code 118. That is, the GPU 104 may execute the bezel mitigation code 118 (as executable instructions) from the memory 105 in some embodiments.

In some examples, the bezel mitigation logic 117 may communicate (e.g., via the graphics drivers 115) with a 3D head position sensor 119 to determine changes in a head position of a user. 3D head position sensor 119 may, in some non-limiting examples, comprise one or more front-facing cameras, and may be configured to track head position (for example, at 30 frames per second, or faster or slower). Furthermore, 3D head position sensor 119 may communicate with GPU 104, which may assist in determining that a head position change has occurred using one or more image analysis algorithms and/or by using sum-of-differences hardware. In an additional aspect, 3D head position sensor 119 may be configured to detect eye position, and may be configured to determine one or more head position changes regardless of whether the user has oriented his or her head vertically. In some examples, the displayed images use a position at the midpoint between the two eyes as a close approximation for what each eye would see of the virtual image. When the head position changes in any dimension (x, y, or z), the rendering hardware or software in the GPU 104 and/or CPU 103 may adjust at frame display rates to reveal a different view of the virtual image, shifting the image and/or adjusting the virtual image perspective as viewed by the user.

In an aspect of the present disclosure, if the amount of image shift exactly matches the amount of head motion or detected head position change, the virtual image is at infinity. It moves by a fraction f between zero and one; at zero, the physical and the virtual image are the same and there is no bezel suppression. A small value of f means the user must move parallel to the screens by roughly d/f; where d is the distance between physical displays caused by the bezels and any additional space between bezels. Thus, in some non-limiting examples, a position for the virtual image may be infinity, since it leads to the minimum amount of head motion to “see around” the bezels. Currently, one can obtain and tile displays such that the distance between physical images is less than four centimeters, which is a comfortable distance for a user to move his or her head while seated.

Furthermore, while this techniques disclosed herein could be applied in the 3D-image context, it may be applied to the display of 2D images as well. In an aspect, the methods, devices, and systems herein apply to any situation where displays are tiled to present more pixel information of a continuous image. For example, one could put a one-page document on a two-by-two set of screens, and the words “hidden” behind the bezels and space between screens would be viewable by moving the head slightly to view the images.

Additionally, when combined with stereoscopic viewing methods where a different image is directed to each eye, the methods of this disclosure may increase the immersive effect of the 3D image, and potentially reduce the occurrence of headaches when viewing stereoscopic 3D. In purely stereoscopic 3D, the image may not change correctly when head position of the user changes. If the separate eye images are produced on a head-mounted display, then the visual images contradict kinesthetic sense, because though the brain expects the view of an image to change with the slightest head motion, it does not. If the separate eye images are produced on a stationary physical display, the images are only correct for a precise head location, and any deviation will cause some perspective in the image, “warping,” and spoiling the illusion of proper 3D. The use of virtual images as described herein solves this inherent problem and concurrently solves the problem of bezel spacing between images because it creates the illusion of seeing a world through window panes that lies behind the physical displays and is updated properly with the head motion of the user.

Moreover, the methods, devices, and systems disclosed herein are not limited to situations with more than one display. Even a single display is enhanced by letting the user change head positions to “see behind” the bezels bordering the screen. Some systems do this by requiring the user to move a mouse or other pointer, or press keys on a keyboard to shift the screen up or down, but this is unnatural and can cause confusion when using a pointer device that sometimes moves independently of a stationary image and sometimes “pulls” the image as a side effect. As an example of an improved user interface, many operating systems display a strip of icons representing commonly-used applications or open documents; those could be kept just out of sight of the user, but moving the head slightly would reveal them “behind the bezel” on the border of the screen.

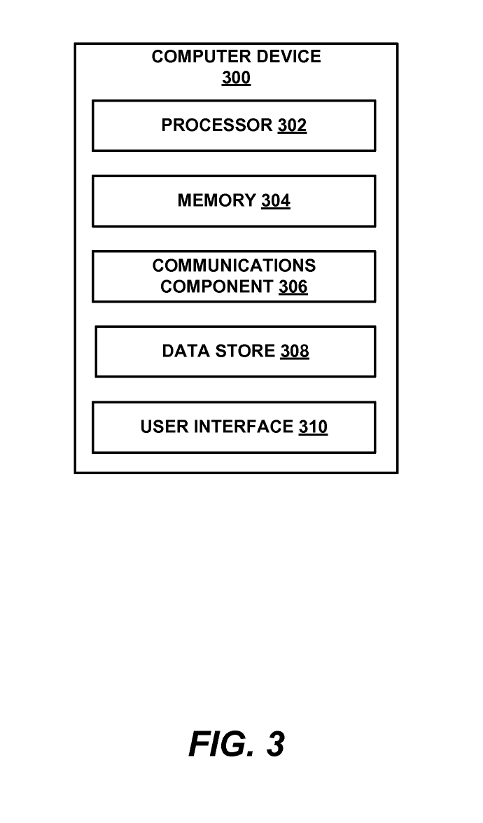

Referring to FIG. 3, in one aspect, any of apparatus 100 and/or display devices 101 of FIG. 1 may be represented by a specially programmed or configured computer device 300. Computer device 300 includes a processor 302 for carrying out processing functions associated with one or more of components and functions described herein. Processor 302 can include a single or multiple set of processors or multi-core processors. Moreover, processor 302 can be implemented as an integrated processing system and/or a distributed processing system. In some examples, processor 302 may comprise CPU 103 and/or GPU 104 of FIG. 1.

Computer device 300 further includes a memory 304, such as for storing data used herein and/or local versions of applications being executed by processor 302. Memory 304 can include any type of memory usable by a computer, such as random access memory (RAM), read only memory (ROM), tapes, magnetic discs, optical discs, volatile memory, non-volatile memory, and any combination thereof. In some examples, memory 304 may comprise memory 105 of FIG. 1.

Further, computer device 300 includes a communications component 306 that provides for establishing and maintaining communications with one or more parties utilizing hardware, software, and services as described herein. Communications component 306 may carry communications between components on computer device 300, as well as between computer device 300 and external devices, such as devices located across a communications network and/or devices serially or locally connected to computer device 300. For example, communications component 306 may include one or more buses, and may further include transmit chain components and receive chain components associated with a transmitter and receiver, respectively, or a transceiver, operable for interfacing with external devices. In an additional aspect, communications component 306 may be configured to receive one or more pages from one or more subscriber networks.

Additionally, computer device 300 may further include a data store 308, which can be any suitable combination of hardware and/or software, that provides for mass storage of information, databases, and programs employed in connection with aspects described herein. For example, data store 308 may be a data repository for applications not currently being executed by processor 302.

Computer device 300 may additionally include a user interface component 310 operable to receive inputs from a user of computer device 300, and further operable to generate outputs for presentation to the user. User interface component 310 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 310 may include one or more output devices, including but not limited to a display, a speaker, a haptic feedback mechanism, a printer, any other mechanism capable of presenting an output to a user, or any combination thereof.

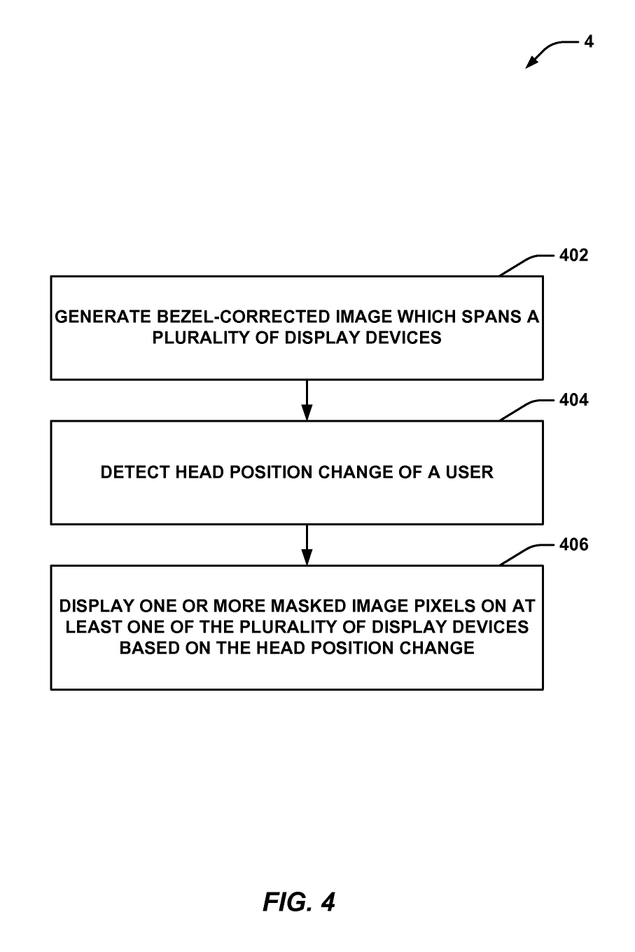

FIG. 4 illustrates an example method for bezel mitigation in multi-display devices according to aspects of the present disclosure. For example, such methods may include a method 4 of operating a video device, as shown in FIG. 4. In an aspect, such an example method may include, at block 402, generating a bezel-corrected image that spans a plurality of display devices. Such a bezel-corrected image may include masked image pixels, where the masked image pixels are associated with a bezel of at least one of the plurality of display devices. Additionally, in some examples, generating a bezel-corrected image at block 402 may further comprise one or more sub-processes, which may include generating a source image of one or more objects, the source image having a viewing frustum based on physical image pixels of each of the plurality of display devices and a projection reference point. In some examples, the projection reference point may be independent of the head position of the user. Such sub-processes may additionally or alternatively include extending the viewing frustum to an extended viewing frustum of an extended source image based on a location and a dimension of the bezel along a common border between adjacent display devices. Furthermore, in some examples, the extended viewing frustum may include one or more objects that correspond to the masked pixels.

In alternative or additional examples, generating the bezel-corrected image may include displaying a calibration image that spans across the plurality of display devices, receiving bezel correction information in response to a user input to align a display portion of the plurality of display devices based on the displayed calibration image, and aligning the display portion of the plurality of display devices based on the user input such that the calibration image spans continuously across the plurality display devices.

Furthermore, in some examples, generating the bezel-corrected image may include generating a virtual image having a frustum larger than the extended viewing frustum and a projection reference point based on the head position change. In such examples, the virtual image may include objects and corresponding masked image pixels outside of the extended viewing frustum. Furthermore, according to some examples of method 4, generating the virtual image may include extending a depth between a far plane of the viewing frustum and the corresponding projection reference point.

As illustrated in FIG. 4, method 4 may further include, at block 404, detecting a head position change of a user. Furthermore, method 4 may include displaying one or more of the masked image pixels on at least one of the plurality of display devices based on the head position change at block 406.

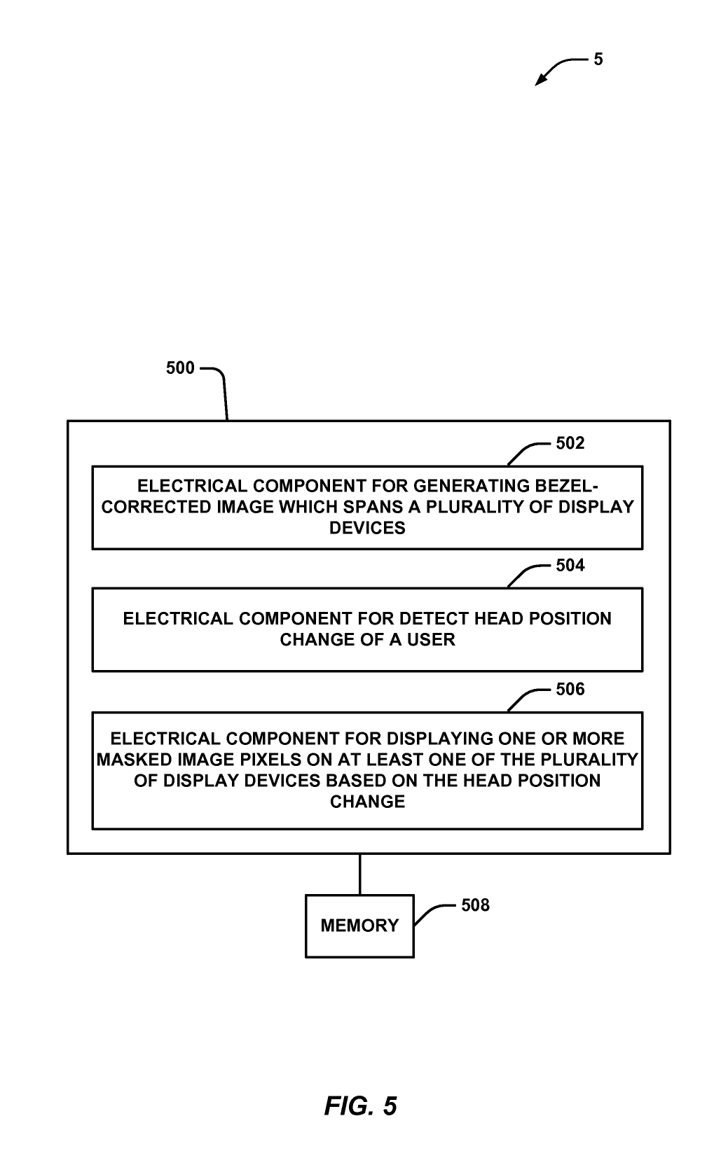

Referring to FIG. 5, an example system 5 is illustrated for mitigating the effects of bezels on images displayed by multi-device displays. For example, system 5 can reside at least partially within one or more apparatuses (e.g., apparatus 100 or display devices 101 of FIG. 1). It is to be appreciated that system 5 is represented as including functional blocks, which can be functional blocks that represent functions implemented by a processor, software, or combination thereof (e.g., firmware). System 5 includes a logical grouping 500 of electrical components that can act in conjunction. For instance, logical grouping 500 can include an electrical component 502 for generating a bezel-corrected image that spans a plurality of display devices. In an aspect, electrical component 502 may comprise CPU 103, GPU 104, or any other component of FIG. 1. Additionally, logical grouping 500 can include an electrical component 504 for detecting a head position change of a user. In an aspect, electrical component 504 may comprise 3D head position sensor 119 (FIG. 1). In an additional aspect, logical grouping 500 can include an electrical component 506 for displaying one or more masked image pixels on at least one of the plurality of display devices based on the head position change. In an aspect, electrical component 506 may comprise CPU 103, GPU 104, or any other component of FIG. 1.

Additionally, system 5 can include a memory 508 that retains instructions for executing functions associated with the electrical components 502, 504, and 506, stores data used or obtained by the electrical components 502, 504, and 506, etc. While shown as being external to memory 508, it is to be understood that one or more of the electrical components 502, 504, and 506 can exist within memory 508. In one example, electrical components 502, 504, and 506 can comprise at least one processor, or each electrical component 502, 504, and 506 can be a corresponding module of at least one processor. Moreover, in an additional or alternative example, electrical components 502, 504, and 506 can be a computer program product including a computer readable medium, where each electrical component 502, 504, and 506 can be corresponding code.

Also, integrated circuit design systems/integrated fabrication systems (e.g., work stations including, as known in the art, one or more processors, associated memory in communication via one or more buses or other suitable interconnect and other known peripherals) are known that create wafers with integrated circuits based on executable instructions stored on a computer-readable medium such as, but not limited to, CDROM, RAM, other forms of ROM, hard drives, distributed memory, etc. The instructions may be represented by any suitable language such as, but not limited to, hardware descriptor language (HDL), Verilog or other suitable language. As such, the logic, software and circuits described herein may also be produced as integrated circuits by such systems using the computer-readable medium with instructions stored therein. For example, an integrated circuit with the aforementioned software, logic and structure may be created using such integrated circuit fabrication systems. In such a system, the computer readable medium stores instructions executable by one or more integrated circuit design systems that cause the one or more integrated circuit design systems to produce an integrated circuit.

The above detailed description and the examples described therein have been presented for the purposes of illustration and description only and not for limitation. For example, the operations described may be done in any suitable manner. The method may be done in any suitable order still providing the described operation and results. It is therefore contemplated that the present embodiments cover any and all modifications, variations or equivalents that fall within the spirit and scope of the basic underlying principles disclosed above and claimed herein. Furthermore, while the above description describes hardware in the form of a processor executing code, hardware in the form of a state machine or dedicated logic capable of producing the same effect is also contemplated.

What is claimed is:

1. A method of operating a video device comprising:
generating a bezel-corrected image which spans a plurality of display devices, the bezel-corrected image including masked image pixels, wherein the masked image pixels are associated with a bezel of at least one of the plurality of display devices;
detecting a head position change of a user; and
displaying one or more of the masked image pixels on at least one of the plurality of display devices based on the head position change.

2. The method according to claim 1, wherein generating a bezel-corrected image further includes:
generating a source image of one or more objects, the source image having a viewing frustum based on physical image pixels of each of the plurality of display devices and a projection reference point, wherein the projection reference point is independent of a head position of the user; and
extending the viewing frustum to an extended viewing frustum of an extended source image based on a location and a dimension of the bezel along a common border between adjacent display devices, wherein the extended viewing frustum includes one or more objects that correspond to the masked pixels.

3. The method according to claim 2, wherein generating a bezel-corrected image further comprises generating a virtual image having a frustum larger than the extended viewing frustum and a projection reference point based on the head position change, the virtual image including objects and corresponding masked image pixels outside of the extended viewing frustum.

4. The method according to claim 3, wherein generating the virtual image comprises extending a depth between a far plane of the viewing frustum and the corresponding projection reference point.

5. The method according to claim 3, wherein the objects of the source image, extended source image, and virtual image are at least one of two-dimensional objects and three-dimensional objects.

6. The method according to claim 3, further comprising displaying the masked image pixels on the corresponding display device based on the head position change.

7. The method according to claim 3, wherein the orientation of the projection reference point is adjusted in three dimensions based on the head position change.

8. The method according to claim 1, wherein generating a bezel-corrected image further comprises:
displaying a calibration image that spans across the plurality of display devices;
receiving bezel correction information in response to a user input to align a display portion of the plurality of display devices based on the displayed calibration image; and
aligning the display portion of the plurality of display devices based on the user input such that the calibration image spans continuously across the plurality display devices.

9. A video device comprising:
a plurality of display devices configured to display an image which spans continuously across the plurality of display devices;
at least one processor; and
memory operatively coupled to at least one processor, wherein the memory contains instructions for execution by the at least one processor, wherein at least one processor, upon executing the instructions, is operable to:
generate a bezel-corrected image that spans the plurality of display devices, the bezel-corrected image including masked image pixels, wherein the masked image pixels are associated with a bezel of at least one of the plurality of display devices;
detect a head position change of a user; and
display one or more of the masked image pixels on at least one of the plurality of display devices based on the head position change.

10. The video device according to claim 9, wherein the memory contains instructions for execution by at least one processor, wherein at least one processor, upon executing the instructions, is further operable to:
generate a source image of one or more objects, the source image having a viewing frustum based on physical image pixels of each of the plurality of display devices and a projection reference point, wherein the projection reference point is independent of a head position of the user; and
extend the viewing frustum to an extended viewing frustum of an extended source image based on a location and a dimension of the bezel along a common border between adjacent display devices, wherein the extended viewing frustum includes one or more objects that correspond to the masked pixels.

11. The video device according to claim 10, wherein the memory contains instructions for execution by at least one processor, wherein at least one processor, upon executing the instructions, is further operable to generate a virtual image having a frustum larger than the extended viewing frustum and a projection reference point based on the head position change, the virtual image including objects and corresponding masked image pixels outside of the extended viewing frustum.

12. The video device according to claim 11, wherein the virtual image is generated by extending a depth between a far plane of the viewing frustum and the corresponding projection reference point.

13. The video device according to claim 11, wherein the objects of the source image, extended source image, and virtual image are at least one of two-dimensional objects and three-dimensional objects.

14. The video device according to claim 11, wherein the memory contains instructions for execution by the at least one processor, wherein at least one processor, upon executing the instructions, is further operable to display the masked image pixels on the corresponding display device based on the head position change.

15. The video device according to claim 11, wherein the orientation of the projection reference point is adjusted in three dimensions based on the head position change.

16. The video device according to claim 9, wherein the memory contains instructions for execution by the at least one processor, wherein at least one processor, upon executing the instructions, is further operable to:
display a calibration image that spans across the plurality of display devices;
receive bezel correction information in response to a user input to align a display portion of the plurality of display devices based on the displayed calibration image; and
align the display portion of the plurality of display devices based on the user input such that the calibration image spans continuously across the plurality display devices.

17. A computer readable memory comprising:
executable instructions for execution by at least one processors, that when executed cause the at least one processor to:
generate a bezel-corrected image which spans a plurality of display devices, the bezel-corrected image including masked image pixels, wherein the masked image pixels are associated with a bezel of at least one of the plurality of display devices;
detect a head position change of a user; and
display one or more of the masked image pixels on at least one of the plurality of display devices based on the head position change.

18. The computer readable memory of claim 17, wherein the executable instructions to generate the bezel-corrected image, when executed, further cause the at least one processor to:
generate a source image of one or more objects, the source image having a viewing frustum based on physical image pixels of each of the plurality of display devices and a projection reference point, wherein the projection reference point is independent of a head position of the user; and
extend the viewing frustum to an extended viewing frustum of an extended source image based on a location and a dimension of the bezel along a common border between adjacent display devices, wherein the extended viewing frustum includes one or more objects that correspond to the masked pixels.

19. The computer readable memory of claim 18, wherein the executable instructions to generate the bezel-corrected image, when executed further cause at least one processor to generate a virtual image having a frustum larger than the extended viewing frustum and a projection reference point based on the head position change, the virtual image including objects and corresponding masked image pixels outside of the extended viewing frustum.

20. The computer readable memory of claim 19, wherein the virtual image is generated by extending a depth between a far plane of the viewing frustum and the corresponding projection reference point.
